(19) United States
(12) Patent Application Publication
(10) Pub. No.: US 2023/0121485 A1
(43) Pub. Date: Apr. 20, 2023

(54) IMAGE PROCESSING METHOD, PHOTOGRAPHING DEVICE, AND UAV

(71) Applicant: AUTEL ROBOTICS CO., LTD., Shenzhen (CN)

(72) Inventor: Zhaozao LI, Shenzhen (CN)

(21) Appl. No.: 18/069,425

(22) Filed: Dec. 21, 2022

Related U.S. Application Data
(63) Continuation of application No. PCT/CN2021/100964, filed on Jun. 18, 2021.

(30) Foreign Application Priority Data
Jun. 24, 2020 (CN) 202010592665.1

(51) Int. Cl. H04N 23/667; H04N 23/951; B64U 20/87; B64C 39/02

(52) U.S. Cl. CPC H04N 23/667; H04N 23/951; B64U 20/87; B64C 39/024; B64U 2101/30

(57) ABSTRACT

Embodiments of the present invention are an image processing method, a photographing device, and a storage medium. The method includes: acquiring an image according to a first resolution and processing the image in a first processing method in a real-time preview state, switching to a photographing state, acquiring an image according to a second resolution and processing the image in a second processing method in the photographing state, and then switching from the photographing state to the real-time preview state. In this way, in a process of switching between the two working states, the image can be processed in a corresponding state without restarting an ISP or re-importing a parameter. Compared with a method of switching different working states by powering on and off the ISP in the prior art, the method provided in the present application can achieve faster dynamic switching between different working states.

### CROSS-REFERENCE TO RELATED APPLICATIONS

The present application is a continuation of International Application No. PCT/CN2021/100964, filed on Jun. 18, 2021, which claims priority to Chinese Patent Application No. 2020105926651, filed on Jun. 24, 2020, which is incorporated herein by reference in its entirety.

### TECHNICAL FIELD

Embodiments of the present invention relate to image processing technologies, and in particular, to an image processing method, a photographing device, and an UAV.

### BACKGROUND

An aerial camera, that is, a photographing device carried by an unmanned aerial vehicle (UAV), is usually used for achieving one of the following functions: obtaining a high-definition image or obtaining video data in real time to enable the video data to be previewed at a client in real time. If the two functions need to be achieved, dynamic switching is required. Efficiency of switching between the functions is affected because an image processing unit performs different processing methods on images under the two modes, thereby reducing user experience.

### SUMMARY

The present invention provides an image processing method, a photographing device, and an UAV, through which fast dynamically switching between different working states can be achieved.

According to a first aspect, an embodiment of the present invention provides an image processing method, applied to a photographing device of an unmanned aerial vehicle (UAV), the method including:

acquiring a first image according to a first resolution in a real-time preview state, processing the first image according to a first processing method, and transmitting the processed first image to a user terminal in communication with the UAV, where the first resolution is less than a highest resolution pre-configured by the photographing device;

receiving a state switching instruction, where the state switching instruction is used for switching from the real-time preview state to a photographing state;

acquiring a second image according to a second resolution in the photographing state, processing the second image according to a second processing method, and storing the processed second image, where the second resolution is greater than the first resolution and the second resolution is less than or equal to the highest resolution; and

switching from the photographing state to the real-time preview state.

According to a second aspect, an embodiment of the present invention further provides a photographing device, arranged on the UAV, the device including:

an image acquisition sensor, configured to acquire a first image according to a first resolution in a real-time preview state or acquire a second image according to a second resolution in a photographing state,

where the first resolution is less than a highest resolution pre-configured by the photographing device, and the second resolution is less than or equal to the highest resolution;

an image processing unit, configured to process the first image according to a first processing method or process the second image according to a second processing method;

a communication module, configured to transmit the processed first image to a user terminal in communication with the UAV;

a receiving module, configured to receive a state switching instruction, where the state switching instruction is used for switching from the real-time preview state to the photographing state;

a storage module, configured to store the processed second image; and

a switching module, configured to switch from the photographing state to the real-time preview state.

According to a third aspect, an embodiment of the present invention further provides a computer-readable storage medium. The computer-readable storage medium stores a computer program, the computer program, when executed by a processor, implementing the image processing method provided in any embodiment of the present invention.

According to a fourth aspect, an embodiment of the present invention further provides a photographing device, the device including:

a memory, a processor, and a computer program stored on the memory and executable on the processor, the processor, when executing the computer program, implementing the image processing method provided in any embodiment of the present invention.

According to an image processing method, a photographing device, and an UAV provided in the embodiments of the present application, an image can be acquired according to a first resolution and processed in a first processing method in a real-time preview state, a photographing state is switched to, an image can be acquired according to a second resolution and processed in a second processing method in the photographing state, and then the photographing state is switched to the real-time preview state. In this way, in a process of switching between the two working states, the image can be processed in a corresponding state without restarting an ISP or re-importing a parameter. Compared with a method of switching different working states by powering on and off the ISP in the prior art, the method provided in the present application can achieve faster dynamic switching between different working states.

### BRIEF DESCRIPTION OF THE DRAWINGS

FIG. 1 is a schematic flowchart of aerial camera processing in the prior art.

FIG. 2 is a flowchart of an image processing method according to an embodiment.

FIG. 3 is a schematic diagram of a photographing state.

FIG. 4 is a schematic diagram of a real-time preview state.

FIG. 5 is a schematic structural diagram of a photographing device according to an embodiment.

FIG. 6 is a schematic structural diagram of a photographing device according to an embodiment.

### DETAILED DESCRIPTION

The following further describes the present invention in detail with reference to the accompanying drawings and embodiments. It may be understood that specific embodiments described herein are only intended to explain the present invention, rather than limit the present invention. In addition, it should be further noted that, for ease of description, the accompanying drawings only show parts relevant to the present invention rather than the entire structure.

In addition, in the embodiments of the present application, the word, such as “optionally” or “exemplarily”, is used to represent giving an example, an illustration, or a description. Any embodiment or design scheme described as “optionally” or “exemplarily” in the embodiments of the present invention should not be explained as being more preferred or having more advantages than another embodiment or design scheme. Exactly, use of the word, “optionally”, “exemplarily”, or the like, is intended to present a related concept in a specific manner.

As shown in FIG. 1, a whole processing flow of an aerial camera is as follows: after using a high-definition image acquisition sensor to acquire an image, the aerial camera inputs the image to an image signal processor (ISP), and after processed by the ISP, the acquired image is respectively transmitted to a photographing module and a preview module.

However, because an overall performance A of outputting an image by each image acquisition sensor is fixed, this performance limits a resolution (an image whose width is w and height is h) and frame rate f of the image, as shown in Formula (1):

A=w×h×f (1)

If the acquired image uses a maximum resolution, that is, w and h are maximum, it can be seen from Formula (1) that a frame rate f of the image is relatively low, and this resolution and frame rate are more suitable for a photographing scenario. If the frame rate requires to be increased, the resolution of the image requires to be decreased, which is applied to an image preview scenario.

A dynamic switching method is usually adopted when high-definition resolution photographing and high frame rate real-time preview are implemented. For example, assuming that it is currently in an image preview mode and needs to switch to a photographing mode, it is necessary to stop obtaining a data rate of high frame rate preview, close an encoding channel in a preview mode, and then disable ISP processing. The ISP processing mainly includes automatic exposure, denoising, image enhancement, Gamma processing, and the like. Furthermore, image acquisition in the preview mode is disabled, and high-resolution image acquisition is enabled, that is, a working mode of the image acquisition sensor is switched from the preview mode to the photographing mode, so that a low resolution and a high frame rate are switched to a high resolution and a low frame rate. Then the ISP processing is enabled, and an effect parameter, such as shutter, gain, white balance, color style, and the like, of a photographed image is loaded. Further, coding of high-definition photographing is enabled.

An ISP in the photographing mode is different from an ISP in the preview mode. The ISP in the photographing mode focuses on intra-frame image processing, while is weak on inter-frame image processing. For example, time domain denoising is not performed in the photographing mode. Similarly, encoding in the photographing mode is different from encoding in the preview mode. JPEG/DNG encoding is generally adopted in the photographing mode, and H264/H265 encoding is generally adopted in the preview mode.

After the photographing mode is switched to, image acquisition can be performed in a high-definition resolution, the acquired image can be encoded under a new ISP parameter to obtain a JPEG/DNG picture, and the picture is saved to a storage disk. Certainly, if it is in a continuous shooting or timing shooting scenario, a process of photographing and saving a picture can continue.

When photographing is finished and the photographing mode is switched to the preview mode, photographing encoding, ISP, and image acquisition can be disabled. Then image acquisition and ISP in the preview mode are enabled, an image parameter in the preview mode is loaded, corresponding encoding is enabled, and real-time preview is resumed.

However, because a processing process of the ISP in the preview mode involves image processing between multiple frames such as automatic exposure and time domain denoising, if the ISP is disabled and then restarted, and the image parameter is reloaded, it will generally take effect on an image after several frames, resulting in a relatively large time delay of dynamic switching.

Based on a problem existing in the foregoing scenarios, the embodiments of the present application provide an image processing method, which may be applied to a photographing device of an unmanned aerial vehicle (UAV). As shown in FIG. 2, the method includes:

S201. Acquire a first image according to a first resolution in a real-time preview state, process the first image according to a first processing method, and transmit the processed first image to a user terminal in communication with the UAV.

In this embodiment of the present application, the first resolution may be less than a highest resolution pre-configured by the photographing device. That is, according to this step, in the real-time preview state, the photographing device in the UAV can process the first image acquired according to the first resolution less than the highest resolution and transmit the first image to the user terminal, instead of acquiring the first image according to the highest resolution.

Because an overall performance of outputting an image by the image acquisition sensor is fixed, compared to the method of acquiring the first image at the highest resolution of the photographing device, in this step, the first image is acquired at the first resolution lower than the highest resolution, which can increase a frame rate of the first image by reducing an image resolution. That is, the first image can be previewed at a high frame rate at the user terminal.

S202. Receive a state switching instruction.

Exemplarily, the state switching instruction may be used for instructing state switching of the photographing device, for example, a real-time preview state of the photographing device is switched to a photographing state.

Optionally, the switching instruction may be sent after the image acquisition sensor in the photographing device is reset, that is, the image acquisition sensor is reset to switch from the real-time preview state to the photographing state, and the ISP does not need to be restarted during the switching process.

S203. Acquire a second image according to a second resolution in the photographing state, process the second image according to a second processing method, and store the processed second image.

In this embodiment of the present application, the second resolution may be greater than the first resolution and less than or equal to the highest resolution of the photographing device. That is, in this embodiment of the present application, the first image is acquired at the first resolution which is relatively lower in the real-time preview state, and the second image is acquired at the second resolution which is relatively higher in the photographing state. Furthermore, an image acquired at a higher resolution is processed and then stored. In this way, compared with the real-time preview state, an image with high resolution and low frame rate can be acquired and stored in the photographing state.

S204. Switch from the photographing state to the real-time preview state.

Based on the foregoing steps S201 to S203, after the first image is acquired and processed in the real-time preview state, the photographing state is switched to, the second image is acquired and processed, and then the photographing state is switched back to the real-time preview state.

Exemplarily, the photographing device may be triggered to switch from the photographing state to the real-time preview state through a state back-switching instruction. For example, by resetting the image acquisition sensor, the state back-switching instruction is issued to switch the photographing state of the photographing device to the real-time preview state.

This embodiment of the present application provides an image processing method. The method includes: acquiring an image according to a first resolution which is less than a highest resolution of a photographing device and processing the image in a first processing method in a real-time preview state, switching to a photographing state, acquiring an image according to a second resolution which is greater than the first resolution and processing the image in a second processing method in the photographing state, and then switching from the photographing state to the real-time preview state. In this way, in a process of switching between the two working states, the image can be processed in a corresponding state without restarting an ISP or re-importing a parameter. Compared with a method of switching different working states by powering on and off the ISP in the prior art, the method provided in this embodiment can achieve faster dynamic switching between different working states.

In an example, the photographing device in the foregoing solution may include an image acquisition sensor. The image acquisition sensor is configured to perform image acquisition according to a first resolution or a second resolution.

After the foregoing step S202, the embodiments of the present application further provide an implementation in which the image acquisition sensor is controlled to restart, to cause the image acquisition sensor to perform image acquisition according to the second resolution after restarted; or the image acquisition sensor is controlled to switch a resolution of image acquisition from the first resolution to the second resolution. That is, after a state switching instruction is received, the image acquisition sensor is controlled to work in a second resolution mode corresponding to a photographing state. In this way, flexible switching between different working states of the photographing device can be implemented quickly without restarting the ISP.

Optionally, the photographing device may further include an image processing unit. A processing resolution pre-configured by the image processing unit is a highest resolution of the photographing device, and a quantity of buffer frames pre-configured by the image processing unit is a highest quantity of frames supported by the photographing device.

In an embodiment, this embodiment of the present application provides an optional implementation in which the first image is processed according to the first processing method and then is transmitted to a user terminal in communication with the UAV in step S201. The optional implementation may be as follows: the image processing unit is controlled to buffer the first image according to the highest quantity of frames and the first resolution, process the buffered first image according to the first processing method, and transmit the processed first image to the user terminal in communication with the UAV.

In an embodiment, this embodiment of the present application provides an optional implementation in which the second image is processed according to the second processing method and then stored in step S203. The optional implementation may be as follows: the image processing unit is controlled to buffer the second image to one of the buffer frames pre-configured by the image processing unit according to the second resolution, process the buffered second image according to the second processing method, and store the processed buffered second image.

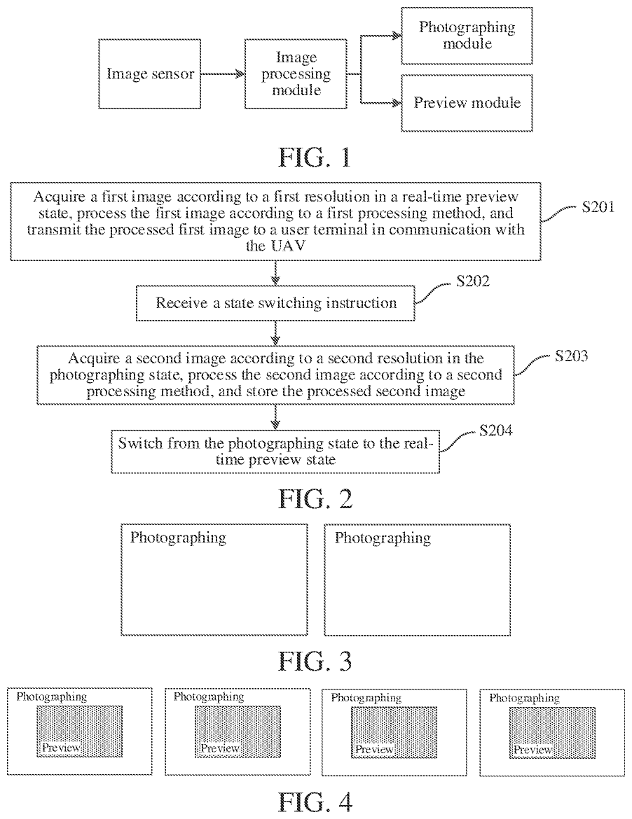

Exemplarily, the first processing method includes loading an image parameter corresponding to the real-time preview state, and the second processing method includes loading an image parameter corresponding to the photographing state. For example, assuming that the photographing device is switched to the photographing state, because a second resolution corresponding to the photographing state is greater than the first resolution and less than or equal to the highest resolution, in the photographing state, the highest resolution may be loaded, the ISP may be switched to a high resolution mode in which a small quantity of buffers are occupied, and an effect parameter of a photographed image may be loaded. In this way, in the high resolution mode, each used buffer frame can be used 100%, and an effect thereof is shown in FIG. 3.

On the contrary, if the photographing state is switched to the real-time preview state, that is, if the photographing device works in the real-time preview state, a first resolution corresponding to the real-time preview state is less than a second resolution. In the real-time preview state, a highest frame rate can be loaded, the ISP can be switched to a high frame rate and low resolution mode, an effect parameter of a preview image can be loaded, and an effect thereof is shown in FIG. 4.

Optionally, in an embodiment of the present application, the photographing device may further receive a power-on initialization instruction to create a highest resolution and a highest frame rate before the photographing device is reset. That is, during power-on initialization, an ISP resolution is created according to a highest resolution of photographing, a quantity of memory buffers, and a highest frame rate required for real-time preview. In this way, when the photographing device is powered on to enter a preview mode, all quantity of buffer frames may be utilized, but each buffer frame only occupies a part of a maximum buffer frame, as shown in FIG. 4.

In an example, the photographing device may further include an encoding unit. The encoding unit is configured to encode a processed image.

In the embodiments of the present application, after step S202, that is, after the state switching instruction is received, the embodiments of the present application further provide an implementation in which the encoding unit is restarted to encode the second image according to an encoding method applicable to the second image; or the encoding method of the encoding unit is switched, to cause the encoding unit to switch from a first encoding method applicable to the first image to a second encoding method applicable to the second image.

For example, assuming that the encoding method applicable to the second image is JPEG/DNG, encoding can be switched to an idle JPEG/DNG encoding channel with a high resolution when the state switching instruction is received to make the photographing device work in the photographing state, and then photographing and image storage can be enabled.

Similarly, when the photographing device switches from the photographing state to the real-time preview state, image encoding thereof is also switched to an encoding method applicable to the first image in the real-time preview state (for example, H264/H265 encoding), that is, the encoding is switched back to a real-time preview channel with a high frame rate.

In addition, when the encoding unit encodes the processed first image or second image, if the encoding channel is a single encoding channel, that is, only one encoding channel is enabled when the photographing device is powered on, encoding of the photographing device in a current state is switched to encoding in another state, and the encoding in another state can be loaded by disabling or restarting. That is, current encoding is disabled and the encoding in another state is restarted. For example, if a current state of the photographing device is the real-time preview state and is required to be switched to the photographing state, switching between encoding methods in these two states may be disabling encoding in the real-time preview state and restarting encoding in the photographing state.

If the encoding channel is a two-way encoding channel, image data acquired by the photographing device in another working state can be bound to an encoding channel corresponding to the state, so as to switch the encoding. Certainly, in this case, when the photographing device receives the power-on initialization instruction, that is, when the photographing device is powered on, two-way encoding may be created. That is, when the photographing device is powered on, high-resolution JPEG/DNG encoding may be created, and low-resolution high-frame-rate H264/H265 encoding may also be created. In this way, when the photographing device works in the real-time preview state, the acquired image data may be bound to a real-time preview encoding channel, and a photographing encoding channel is idle. When the photographing device works in the photographing state, the acquired image data is bound to the photographing encoding channel, and the preview channel is idle.

Certainly, in this embodiment, image acquisition may not need to be enabled or disabled, and it only needs to reset the image acquisition sensor, and implement switching between modes.

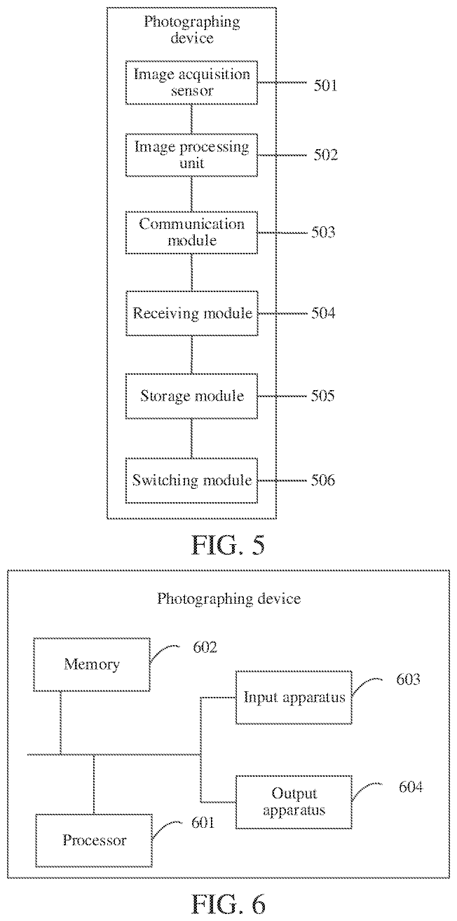

FIG. 5 is a schematic structural diagram of a photographing device according to an embodiment of the present application. As shown in FIG. 5, the apparatus includes an image acquisition sensor 501, an image processing unit 502, a communication module 503, a receiving module 504, a storage module 505, and a switching module 506.

The image acquisition sensor is configured to acquire a first image according to a first resolution in a real-time preview state or acquire a second image according to a second resolution in a photographing state,

where the first resolution is less than a highest resolution pre-configured by the photographing device, and the second resolution is less than or equal to the highest resolution.

The image processing unit is configured to process the first image according to a first processing method or process the second image according to a second processing method.

The communication module is configured to transmit the processed first image to a user terminal in communication with the UAV.

The receiving module is configured to receive a state switching instruction, where the state switching instruction is used for switching from the real-time preview state to the photographing state.

The storage module is configured to store the processed second image.

The switching module is configured to switch from the photographing state to the real-time preview state.

Optionally, the photographing device may further include a control module.

The control module is configured to control the image acquisition sensor to restart, to cause the image acquisition sensor to perform image acquisition according to the second resolution after restarted; or,

control the image acquisition sensor to switch a resolution of image acquisition from the first resolution to the second resolution.

In an example, a processing resolution pre-configured by the image processing unit may be a highest resolution, and a quantity of buffer frames pre-configured by the image processing unit is a supported highest quantity of frames.

Optionally, the control module may further be configured to control the image processing unit to buffer the first image according to the highest quantity of frames and the first resolution, process the buffered first image according to the first processing method, and transmit the processed buffered first image to the user terminal in communication with the UAV.

Optionally, the control module may further be configured to control the image processing unit to buffer the second image to one of buffer frames pre-configured by the image processing unit according to the second resolution, process the buffered second image according to the second processing method, and store the processed buffered second image.

Optionally, the photographing device may further include an encoding unit.

The encoding unit is configured to encode the processed first image or the processed second image.

In an example, the control module is further configured to restart the encoding unit, to cause the encoding unit to encode the second image according to an encoding method applicable to the second image after restarted; or switch the encoding method of the encoding unit, to cause the encoding unit to switch from a first encoding method applicable to the first image to a second encoding method applicable to the second image.

Exemplarily, the first processing method includes loading an image parameter corresponding to the real-time preview state, and the second processing method includes loading an image parameter corresponding to the photographing state.

The image processing apparatus provided in the embodiments of the present invention may perform the image processing method provided in FIG. 2, and has a corresponding functional module and beneficial effect for performing the method.

FIG. 6 is a schematic structural diagram of a photographing device provided in embodiment 6 of the present invention. The photographing device is applied to a UAV. The UAV includes a fuselage and a gimbal mounted on the fuselage. The photographing device is mounted on the gimbal. As shown in FIG. 6, the device includes a processor 601, a memory 602, an input apparatus 603, and an output apparatus 604. There may be one or more processors 601 in the device. One processor 601 is used as an example in FIG. 6. The processor 601, the memory 602, the input apparatus 603, and the output apparatus 604 in the device may be connected through a bus or another method. In FIG. 6, an example in which connection is performed through a bus is used.

The memory 602, as a computer-readable storage medium, may be configured to store a software program, a computer-executable program, and a module, such as a program instruction/module (for example, the image acquisition sensor 501, the image processing unit 502, the communication module 503, the receiving module 504, the storage module 505, and the switching module 506 in the photographing device) corresponding to the image processing method in FIG. 2. The processor 601 runs the software program and module stored in the memory 602, to implement various functional applications and data processing of the photographing device, that is, to implement the foregoing image processing method.

The memory 602 may mainly include a program storage area and a data storage area. The program storage area may store an operating system and an application program required by at least one function. The data storage area may store data created according to use of a camera. In addition, the memory 602 may include a high speed random access memory and may further include a non-volatile memory such as at least one magnetic disk storage device, a flash memory, or another volatile solid storage device. In some embodiments, the memory 602 may further include memories disposed remotely from the processor 801. The remote memories may be connected to a photographing device/terminal/server through a network. Examples of the above network include, but are not limited to, the Internet, an intranet, a local area network, a mobile communication network, and a combination thereof.

The input apparatus 603 may be configured to: receive input digit or character information, and generate a key signal input related to user setting and function control of the photographing device. The output apparatus 604 may include a display component such as a display screen.

The embodiments of the present application further provide a storage medium including a computer executable instruction. The computer executable instruction is used for performing an image processing method when executed by a computer processor, and the method includes:

acquiring a first image according to a first resolution in a real-time preview state, processing the first image according to a first processing method, and transmitting the processed first image to a user terminal in communication with the UAV, where the first resolution is less than a highest resolution supported by the photographing device;

receiving a state switching instruction, where the state switching instruction is used for switching from the real-time preview state to a photographing state;

acquiring a second image according to a second resolution in the photographing state, processing the second image according to a second processing method, and storing the processed second image, where the second resolution is greater than the first resolution and the second resolution is less than or equal to the highest resolution; and

switching from the photographing state to the real-time preview state.

Certainly, the embodiments of the present invention provide a storage medium including a computer executable instruction. The computer executable instruction of the storage medium is not limited to a method operation as described above, but may also perform a related operation in the image processing method provided in any embodiment of the present invention.

Through the descriptions of the foregoing implementations, a person skilled in the art may clearly understand that the present invention may be implemented by software and necessary general hardware, and certainly, may also be implemented by hardware, but in many cases, the former manner is a better implementation. Based on such an understanding, the technical solutions of the present invention essentially, or the part contributing to the prior art may be implemented in the form of a software product. The computer software product may be stored in a computer-readable storage medium, such as a floppy disk, a read-only memory (ROM), a random access memory (RAM), a flash memory (FLASH), a hard disk, or an optical disc of a computer, and includes several instructions for instructing a computer device (which may be a personal computer, a server, a network device, or the like) to perform the methods described in the embodiments of the present invention.

It should be noted that, all units and modules included in the foregoing embodiments are merely divided according to functional logic, and are not limited to the foregoing division as long as a corresponding function can be implemented. In addition, specific names of functional units are also merely for distinguishing from each other, but are not intended to limit the protection scope of the present invention.

It should be noted that the above are merely preferred embodiments of the present invention and applied technical principles. A person skilled in the art may understand that the present invention is not limited to the specific embodiments described herein, and various obvious changes, readjustments, and substitutions can be made by a person skilled in the art without departing from the protection scope of the present invention. Therefore, although the present invention is described in detail through the foregoing embodiments, the present invention is not limited to the foregoing embodiments and may further include more other equivalent embodiments without departing from the concept of the present invention. The scope of the present invention is determined by the scope of the appended claims.

What is claimed is:

1. An image processing method, applied to a photographing device of an unmanned aerial vehicle (UAV), and comprising:
acquiring a first image according to a first resolution in a real-time preview state, processing the first image according to a first processing method, and transmitting the processed first image to a user terminal in communication with the UAV, wherein the first resolution is less than a highest resolution pre-configured by the photographing device;
receiving a state switching instruction, wherein the state switching instruction is used for switching from the real-time preview state to a photographing state;
acquiring a second image according to a second resolution in the photographing state, processing the second image according to a second processing method, and storing the processed second image, wherein the second resolution is greater than the first resolution and the second resolution is less than or equal to the highest resolution; and
switching from the photographing state to the real-time preview state.

2. The method according to claim 1, wherein the photographing device comprises an image acquisition sensor, wherein the image acquisition sensor is configured to perform image acquisition according to the first resolution or the second resolution, and after the receiving a state switching instruction, the method further comprises:
controlling the image acquisition sensor to restart, to cause the image acquisition sensor to perform image acquisition according to the second resolution after restarted; or,
controlling the image acquisition sensor to switch a resolution of image acquisition from the first resolution to the second resolution.

3. The method according to claim 1, wherein the photographing device comprises an image processing unit, wherein a processing resolution pre-configured by the image processing unit is the highest resolution, and a quantity of buffer frames pre-configured by the image processing unit is a supported highest quantity of frames;
the processing the first image according to a first processing method, and transmitting the processed first image to a user terminal in communication with the UAV comprises:
controlling the image processing unit to buffer the first image according to the highest quantity of frames and the first resolution, processing the buffered first image according to the first processing method, and transmitting the processed buffered first image to the user terminal in communication with the UAV; and
the processing the second image according to a second processing method, and storing the processed second image comprises:
controlling the image processing unit to buffer the second image to one of the buffer frames according to the second resolution, processing the buffered second image according to the second processing method, and storing the processed buffered second image.

4. The method according to claim 1, wherein the photographing device comprises an encoding unit, wherein the encoding unit is configured to encode a processed image, and after the receiving a state switching instruction, the method further comprises:
restarting the encoding unit, to cause the encoding unit to encode the second image according to an encoding method applicable to the second image after restarted; or,
switching an encoding method of the encoding unit, to cause the encoding unit to switch from a first encoding method applicable to the first image to a second encoding method applicable to the second image.

5. The method according to claim 1, wherein the first processing method comprises loading an image parameter corresponding to the real-time preview state, and the second processing method comprises loading an image parameter corresponding to the photographing state.

6. A photographing device, arranged on an unmanned aerial vehicle (UAV), comprising:
an image acquisition sensor, configured to acquire a first image according to a first resolution in a real-time preview state or acquire a second image according to a second resolution in a photographing state,
wherein the first resolution is less than a highest resolution pre-configured by the photographing device, and the second resolution is less than or equal to the highest resolution;
an image processing unit, configured to process the first image according to a first processing method or process the second image according to a second processing method;
at least one processor; and,
a memory communicatively connected to the at least one processor, wherein
the memory stores instructions executable by the at least one processor, and the instructions are executed by the at least one processor, to enable the at least one processor to:
transmit the processed first image to a user terminal in communication with the UAV;
receive a state switching instruction, wherein the state switching instruction is used for switching from the real-time preview state to the photographing state;
store the processed second image; and
switch from the photographing state to the real-time preview state.

7. The device according to claim 6, wherein the at least one processor is further configured to:
control the image acquisition sensor to restart, to cause the image acquisition sensor to perform image acquisition according to the second resolution after restarted; or,
control the image acquisition sensor to switch a resolution of image acquisition from the first resolution to the second resolution.

8. The device according to claim 7, wherein the at least one processor is further configured to:
encode the processed first image or the processed second image.

9. The device according to claim 7, wherein the at least one processor is further configured to:
control the image processing unit to buffer the first image according to the highest quantity of frames and the first resolution, process the buffered first image according to the first processing method, and transmit the processed buffered first image to the user terminal in communication with the UAV; and
control the image processing unit to buffer the second image to one of buffer frames pre-configured by the image processing unit according to the second resolution, process the buffered second image according to the second processing method, and store the processed buffered second image.

10. The device according to claim 7, wherein the at least one processor is further configured to perform:
the first processing method and the second processing method, wherein the first processing method comprises loading an image parameter corresponding to the real-time preview state, and the second processing method comprises loading an image parameter corresponding to the photographing state.

11. An unmanned aerial vehicle (UAV), comprising: a fuselage;
a gimbal, arranged on the fuselage; and
a photographing device, arranged at the gimbal, wherein
the photographing device comprises:
an image acquisition sensor, configured to acquire a first image according to a first resolution in a real-time preview state or acquire a second image according to a second resolution in a photographing state,
wherein the first resolution is less than a highest resolution pre-configured by the photographing device, and the second resolution is less than or equal to the highest resolution;
an image processing unit, configured to process the first image according to a first processing method or process the second image according to a second processing method;
at least one processor; and,
a memory communicatively connected to the at least one processor, wherein
the memory stores instructions capable of being executed by the at least one processor, and the instructions are executed by the at least one processor, to enable the at least one processor to:
transmit the processed first image to a user terminal in communication with the UAV;
receive a state switching instruction, wherein the state switching instruction is used for switching from the real-time preview state to the photographing state;
store the processed second image; and
switch from the photographing state to the real-time preview state.

12. The UAV according to claim 11, wherein the at least one processor is further configured to:
control the image acquisition sensor to restart, to cause the image acquisition sensor to perform image acquisition according to the second resolution after restarted; or,
control the image acquisition sensor to switch a resolution of image acquisition from the first resolution to the second resolution.

13. The UAV according to claim 12, wherein the at least one processor is further configured to:
encode the processed first image or the processed second image.

14. The UAV according to claim 12, wherein the at least one processor is further configured to:
control the image processing unit to buffer the first image according to the highest quantity of frames and the first resolution, process the buffered first image according to the first processing method, and transmit the processed buffered first image to the user terminal in communication with the UAV; and
control the image processing unit to buffer the second image to one of buffer frames pre-configured by the image processing unit according to the second resolution, process the buffered second image according to the second processing method, and store the processed buffered second image.

15. The UAV according to claim 12, wherein the at least one processor is further configured to perform:
the first processing method and the second processing method, wherein the first processing method comprises loading an image parameter corresponding to the real-time preview state, and the second processing method comprises loading an image parameter corresponding to the photographing state.
